(19) United States
(12) Patent Application Publication
(10) Pub. No.: US 2010/0198652 A1
(43) Pub. Date: Aug. 5, 2010

(54) System for the Management of Construction Projects

(75) Inventors: Richard William Spanton, JR., Rockton, IL (US); Matthew Michael Spanton, Beloit, WI (US); Max Rahder, Shorewood Hills, WI (US)

Correspondence Address: REINHART BOERNER VAN DEUREN P.C., 2215 PERRYGREEN WAY, ROCKFORD, IL, 61107, US

(73) Assignee: Exact Logix Inc, Rockton, IL (US)

(21) Appl. No.: 12/695,858

(22) Filed: Jan. 28, 2010

Related U.S. Application Data
(60) Provisional application No. 61/148,677, filed on Jan. 30, 2009.

(51) Int. Cl. G06Q 50/00; G06Q 30/00; G06Q 10/00

(52) U.S. Cl. 705/9; 705/26; 705/30; 705/34; 705/301; 705/313; 705/348

(57) ABSTRACT

A computer-based system for managing construction repair project that includes an input device coupled to a processor, an output device coupled to the processor, wherein the processor is programmed to perform certain actions based on user input. The processor is programmed to determine material requirements for the repair project, determine the labor requirement for the repair project, and to generate a cost estimate for the repair project. The processor is also programmed to generate purchase orders for materials based on the material requirements, generate a work crew schedule base on the labor requirements, generate a project schedule that provides a timeline for work to be performed on the repair project, while regularly providing status updates to the user regarding the work performed on the repair project.

### CROSS-REFERENCE TO RELATED PATENT APPLICATIONS

This patent application claims the benefit of U.S. Provisional Patent Application No. 61/148,677, filed on Jan. 30, 2009, the entire teachings and disclosure of which are incorporated herein by reference thereto.

### FIELD OF THE INVENTION

This invention generally relates to the management of construction projects, and, more specifically, to the management of construction repair projects.

### BACKGROUND OF THE INVENTION

Construction repair projects may be fairly complex undertakings from a logistical point of view. Depending on the number of different types of systems in need of repair, it may be necessary to employ and schedule workers having a variety of specialized skills using materials from a number of different suppliers. Further, these workers must often be scheduled only during appropriate phases of the repair project, and their materials must be ready when the work is scheduled to begin. To make matters even more difficult, some work can only begin after the appropriate permit has been obtained from the local agency responsible for overseeing such work.

Needless to say, there are a number of possible ways in which a construction repair project may become delayed. One of these ways involves the failure of the contractor in charge of the project to manage all of the details of the project, especially when the contractor may be managing many such projects at any one time.

It would therefore be desirable to have a system for assisting contractors in dealing with many of the logistical details and other complexities associated with the management of multiple construction repair projects. Embodiments of the invention provide such a system. These and other advantages of the invention, as well as additional inventive features, will be apparent from the description of the invention provided herein.

### BRIEF SUMMARY OF THE INVENTION

In one aspect, embodiments of the invention provide a computer-based system for managing construction repair project that includes an input device coupled to a processor, an output device coupled to the processor, wherein the processor is programmed to perform certain actions based on user input. The processor is programmed to determine material requirements for the repair project, determine the labor requirement for the repair project, and to generate a cost estimate for the repair project. The processor is also programmed to generate purchase orders for materials based on the material requirements, generate a work crew schedule base on the labor requirements, generate a project schedule that provides a timeline for work to be performed on the repair project, while regularly providing status updates to the user regarding the work performed on the repair project.

In another aspect, embodiments of the invention provide a computer-readable storage medium having program instructions stored thereon, which, when executed, cause the computer to process input needed to initiate a construction repair project. The computer-readable storage medium has program instructions further configured to cause the computer to determine material requirements for the repair project, determine the labor requirement for the repair project, and to generate a cost estimate for the repair project. The program instructions stored on the computer-readable storage medium are also configured to cause the computer to generate purchase orders for materials based on the material requirements, generate a work crew schedule base on the labor requirements, generate a project schedule that provides a timeline for work to be performed on the repair project, and to provide status updates to the user regarding the work performed on the repair project.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a block diagram of a system constructed in accordance with an embodiment of the invention;

FIG. 2 is a block diagram of an exemplary information architecture for the system of FIG. 1;

FIG. 3 is a diagram of an exemplary customer page, according to an embodiment of the invention;

FIG. 4 is an example of a display page showing how the managerial lists might appear on a display of the system of FIG. 1;

FIG. 5 is a flowchart illustrating a process for the management of a construction repair project in accordance with an embodiment of the invention;

FIG. 6 shows an example of a repair project cost estimation page, according to an embodiment of the invention;

FIG. 7 shows an alternate embodiment of a repair project cost estimation page, according to an embodiment of the invention;

FIG. 8 is an exemplary illustration of a drawing generated by the system of FIG. 1 based on measurements supplied by the user;

FIG. 9 shows an example of a display that summarizes the major aspects of a repair project for viewing on a single display page;

FIG. 10 shows an example of a display page that provides a listing of material and labor orders associated with a particular repair project; and

FIGS. 11A and 11B are examples of dashboard displays, according to an embodiment of the invention.

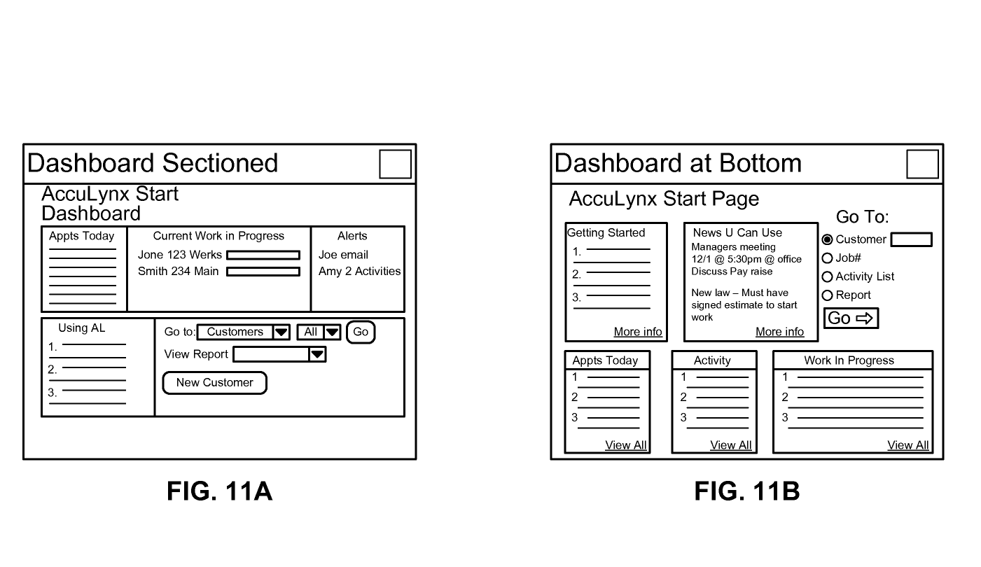

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

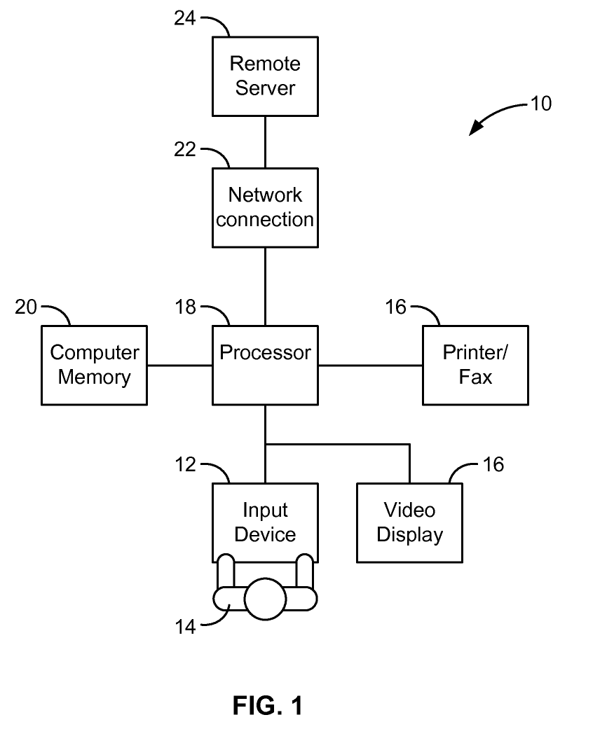

Embodiments of the invention include a computer-based system specifically programmed to facilitate management of construction repair projects. It is contemplated that the system will typically be employed by contractors to improve efficiency, customer service, and quality with respect to the completion of the aforementioned repair projects. FIG. 1 is a block diagram that illustrates an exemplary system 10, constructed in accordance with an embodiment of the invention. In at least one embodiment, the system 10 includes an input device 12 configured to allow a user 14 to log in and input information for a specific repair project. In embodiments of the invention, the input device 12 could be a keyboard, a touch screen display, a computer mouse, or a bar-code reader. Additionally, the system 10 is also configured to allow the user 14 to enter general information that might be relevant to multiple repair projects. Such general information may include the names of preferred suppliers, material costs, local regulations and regulatory costs. The user 14 will also typically enter employee information into the system 10, such as employee name, hourly or salaried wage rate, skill set. Similar information could also be entered for subcontractors or independent contractors.

While the term “user” is used throughout this application in its singular form, one of ordinary skill in the art will recognize that “user,” in the context of this application, may refer to a plurality of individuals who use, maintain, and operate embodiments of the invention described herein.

In at least one embodiment, the system 10 includes an output device 16 configured to present the user 14 with repair project information generated by the system 10. In some cases, the information may be solely for the benefit of the user 14. In other cases, the information may be primarily for presentation to a customer. In embodiments of the invention, the output device 16 could be a video display screen, a computer printer, a facsimile machine, a smart phone, or a personal digital assistance (PDA).

The computer-based system 10 further includes at least one programmable processor 18 configured to process the relevant information and generate data to enable the user 14 to effectively and efficiently manage the repair project. In this embodiment, the program instructions to facilitate management of construction repair projects are stored in computer memory 20 and executed on the processor 18. As will be explained below, in at least one embodiment, the processor 18 is programmed to determine material requirements, labor requirements, regulatory requirements, provide crew work schedules, provide an overall project schedule, and generate total cost estimates for the repair project. In an embodiment, the processor 18 is also programmed to provide customized reports to the user 14 including, but not limited to, sales reports, expense reports, profitability reports, and on-time performance reports. As mentioned above, some user input may be required for the system 10 to provide this range of functionality.

As can be seen from FIG. 1, the processor may also have a network connection 22, for example, to the internet, though other types of network connections 22, such as intranets, and wide-area networks (WANs) are contemplated. The network connection 22 makes it possible for the system 10 to transmit messages to and receive messages from, for example, suppliers, customers, regulatory agencies, and news services via email or the internet. In an alternate embodiment of the invention, the program instructions to facilitate management of construction repair projects are stored on a remote server 24 and executed on a processor (not shown) of the remote server 24. In this embodiment, the output information generated by the remote server 24 is provided to the user 14 via the network connection 20. This output may be displayed on the user's output device(s) 16 and stored in the user's computer memory 20, however the user 14 will not have to maintain the program instructions on his computer.

It is also contemplated that the program instructions, which, when executed, cause the system 10 to carry out the steps that facilitate management of construction repair projects, may be stored on a computer-readable storage medium. For example, a user may store the program instructions on a storage media such that the program instructions may be executed on a computer-based system of the user's choosing. Such computer-readable storage mediums may include, but are not limited to, magnetic disk drives, optical disk drives including DVDs or CDs, flash memory drives, EEPROMS, semiconductor memory, and magnetic tape.

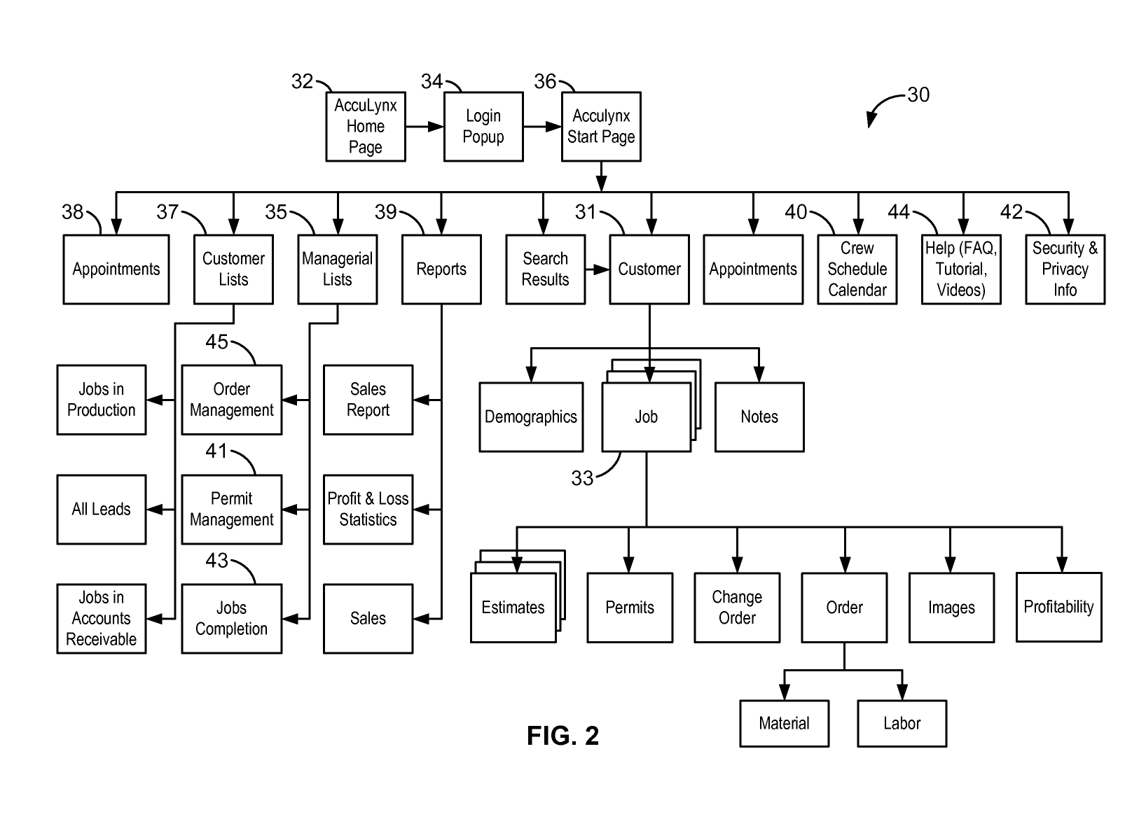

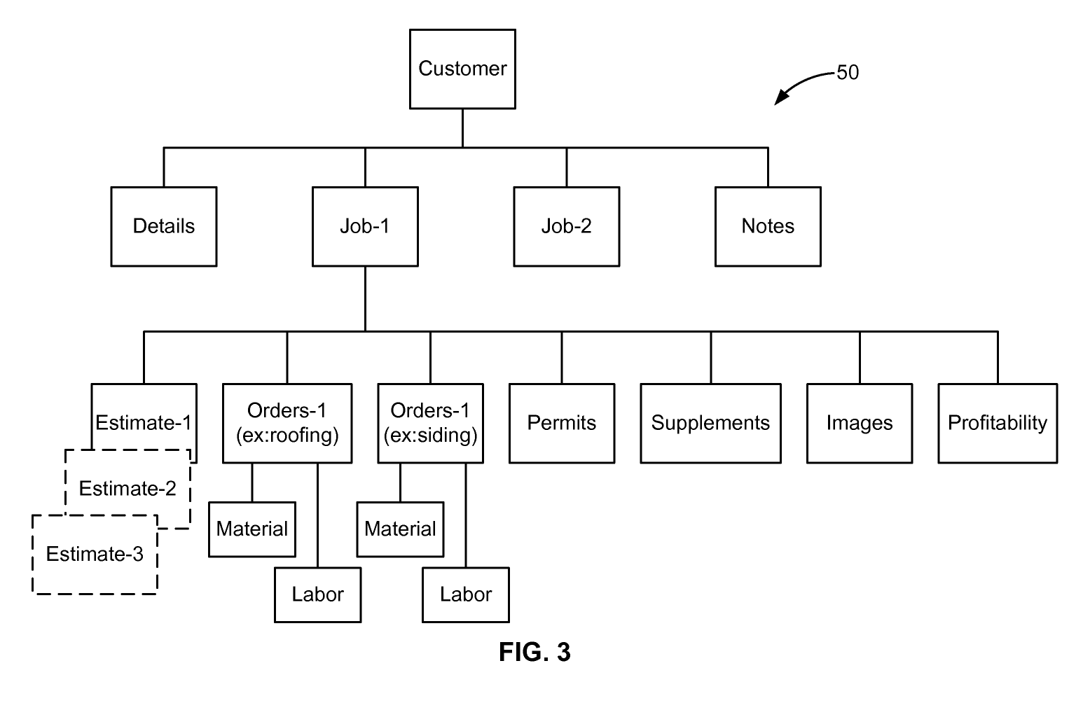

FIG. 2 is a block a diagram of an exemplary information architecture 30 for the system of FIG. 1. As can be seen in FIG. 2, an embodiment of the information architecture 30 includes a home page 32 linked to a log in page 34 linked to a start page 36. From this start page 36, the user has an array of choices including scheduled appointments 38, crew schedule 40, security information 42, and a help screen 44. Additionally, as can be seen from FIG. 2, the information architecture 30 includes detailed information on the customer 31 and the repair job 33. FIG. 3 is a diagram of an exemplary customer page 50, according to an embodiment of the invention. In the example shown, the customer page 50 includes personal (demographic) details about the customer, the repair jobs currently being performed for the customer. Under each particular repair job, the user has access to the estimate provided the customer for the job, the permits applied for, and the labor and material orders placed in connection with the repair job. The user may also have access to photographic images taken on the job, the profitability of the repair job, and any supplemental information associated with the job.

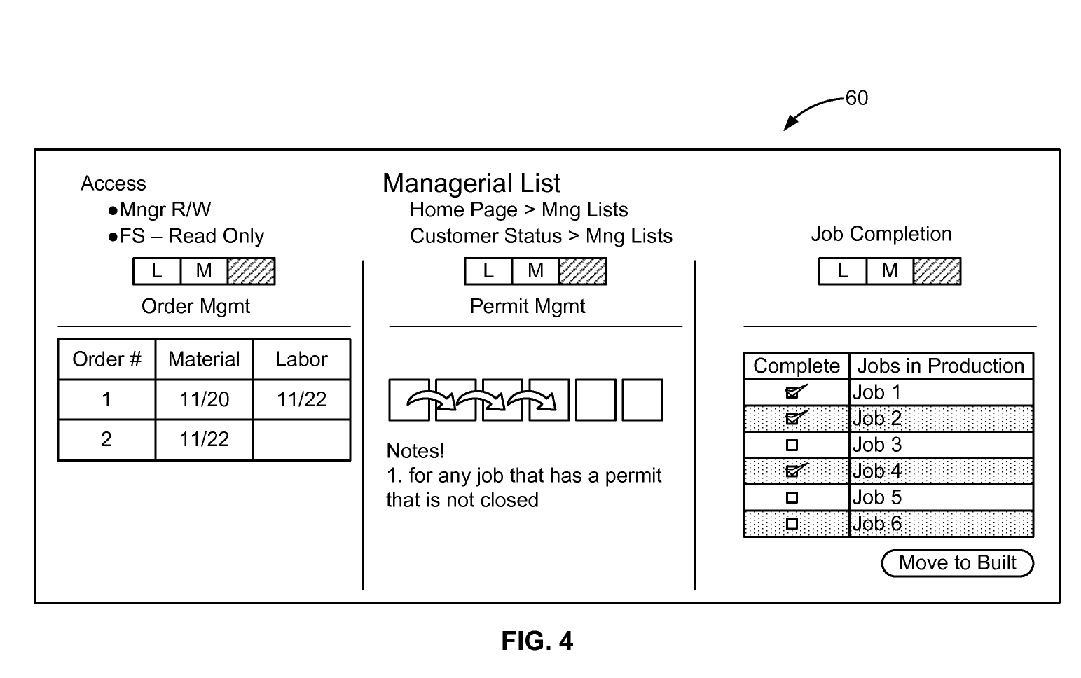

Managerial lists 35, customer lists 37, and a variety of reports 39 are also part of the information architecture 30 and available to the user from the start page 36. Managerial lists 35 may include, for example, a permit management list 41 to show the status of pending permit applications, a job completion list 43 to show the status of current jobs underway, and an order management list 45 to show, for example, due dates for order of materials and other goods. FIG. 4 is an example of a display page 60 showing how the managerial lists might appear on the system display 16. In the exemplary display page 60 of FIG. 4, managerial lists are shown in separate columns across the screen.

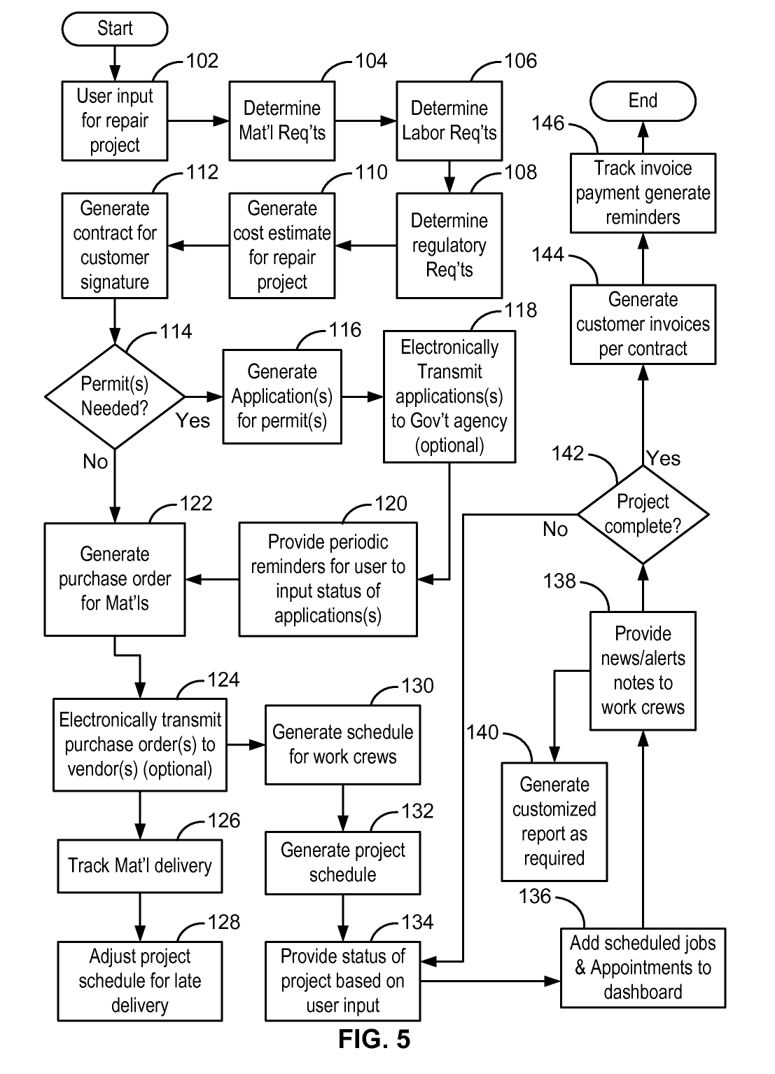

FIG. 5 illustrates a flowchart illustrating a process 100 by which the above-mentioned system 10, constructed in accordance with an embodiment of the invention, can facilitate management of a construction repair project. Typically, the repair project is related to a residential, commercial, or industrial property, however, embodiments of the invention are not limited to these types of repair projects. It is contemplated that a variety of construction projects could be managed by embodiments of the invention disclosed herein. The process 100 shown in FIG. 5 is initiated when a user enters the initial information for a construction repair project 102. In embodiments of the invention, the range of possible repair projects includes, but is not limited to, repairs to roofing, siding, windows, gutter, plumbing, electrical, HVAC, and the foundation. Information for one or more types of repairs may be entered into the system 10 under the umbrella of a single repair project. As a result, a single repair project may include individual repairs to many different parts of the structure being repaired. The means for user-input of information into the system 10 include, but are not limited to, a keyboard, a mouse, and a touch-screen display.

When the information relevant to the repair project is entered into the system 102, the system 10 determines what materials would be required to complete the repair project 104. In at least one embodiment, the material requirements includes the quantities, unit costs, and total cost of the materials required to complete the repair project. In this embodiment, the system 10 permits the user to enter units costs for various materials along with the preferred supplier for the materials, and including volume discounts or other types of discounts or incentives from the supplier. After determining the material requirements for the repair project 104, the system 10 is configured to provide the material requirements to an output device for the benefit of the user. In embodiments of the invention, the output device is one of a computer display screen, a facsimile machine, and a printer.

Based on the user-input, the system 10 also determines the labor requirements for the repair project 106. In at least one embodiment, the labor requirements includes the man-hours, total compensation costs, and total cost of the labor required to complete the repair project. In this embodiment, the system 10 permits the user to enter the hourly or salaried costs for various types of employees, subcontractors, and independent contractors, including overtime costs, if relevant. In an embodiment of the invention, the system 10 is configured to choose workers with the appropriate skills to complete the repair project, and to determine that the workers are available when needed. After determining the labor requirements for the repair project 104, the system 10 is configured to provide the material requirements to the aforementioned output device for the benefit of the user.

Depending on the nature of the repair project, there may be regulatory requirements that call for a permit to be granted, some type of inspection to be performed, or some other type of approval to be obtained either before, during, or after work commences. In these situations, the system 10 is configured to determine if the repair project has any regulatory requirements 108 that must be complied with, and provide information on the applicable regulatory requirements to the output device for the benefit of the user. The information on the regulatory requirements may include, but is not limited to, standards for compliance, the measures that need to be taken to be in compliance with the regulations, the fees and associated costs charged in relation to those regulations, and the average time frame to obtain the necessary approval. Some of this information may need to be entered into the system 10 by the user.

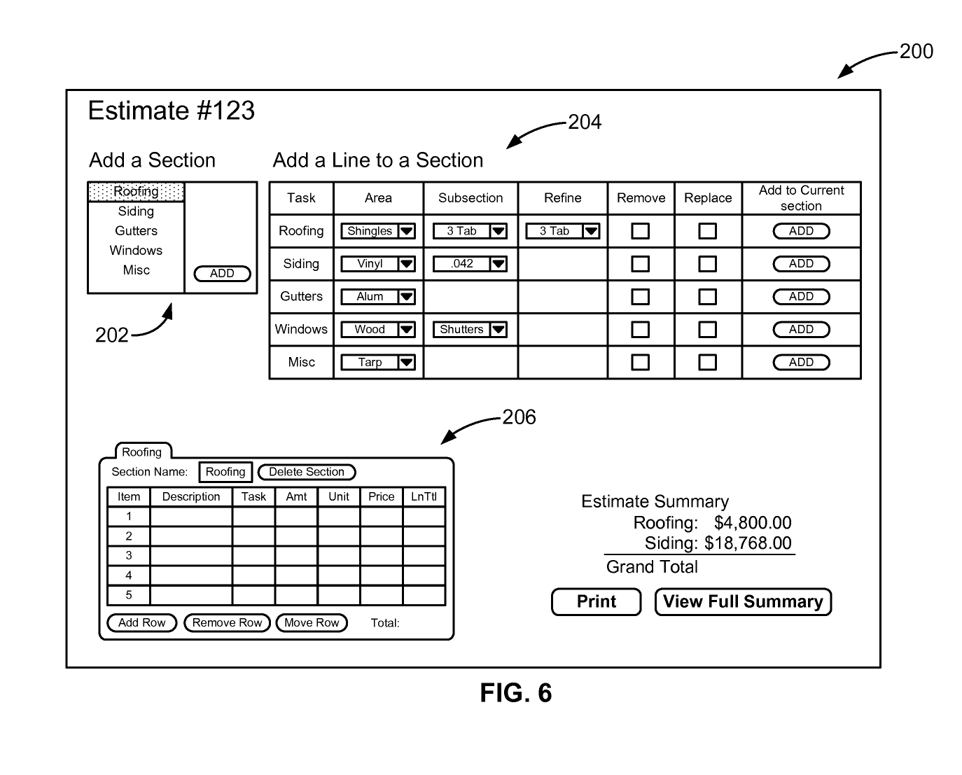

At this point, the system 10 generates a total cost estimate for the repair project 110, which, in at least one embodiment, includes an itemized list of all estimated material costs, labor costs, and regulatory costs. The estimate is based on user input describing the scope of work to be performed. The total cost estimate may be presented to the customer in electronic form, via email for example, or as a printed hardcopy. If the customer agrees to move forward with the repair project, the system 10 can be configured to generate the necessary service contracts 112, based on terms mutually agreed to by the contractor and customer. FIG. 6 shows an example of a display page 200 the user can use in developing a cost estimate for a repair project. In the “Add a Section” area 202, the user can choose one or more of the types of repairs to be included in the overall project, e.g., roofing, siding, windows, etc. The “Add a Line to a Section” area 204 allows the user to customize the job by adding particular job-related tasks and material-related details to any section chosen while in “Add a Section” 202. In a separate section 206, each particular task can be assigned a cost estimate until estimates for all of the tasks associated with a repair project are entered. At this point, the user can view or print a full cost summary.

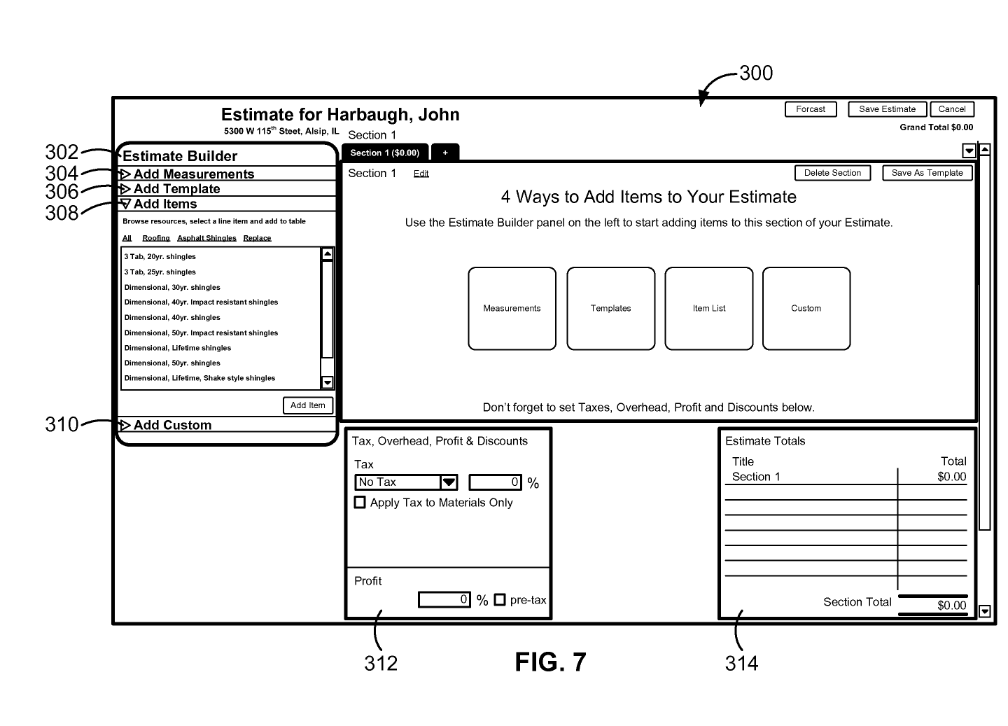

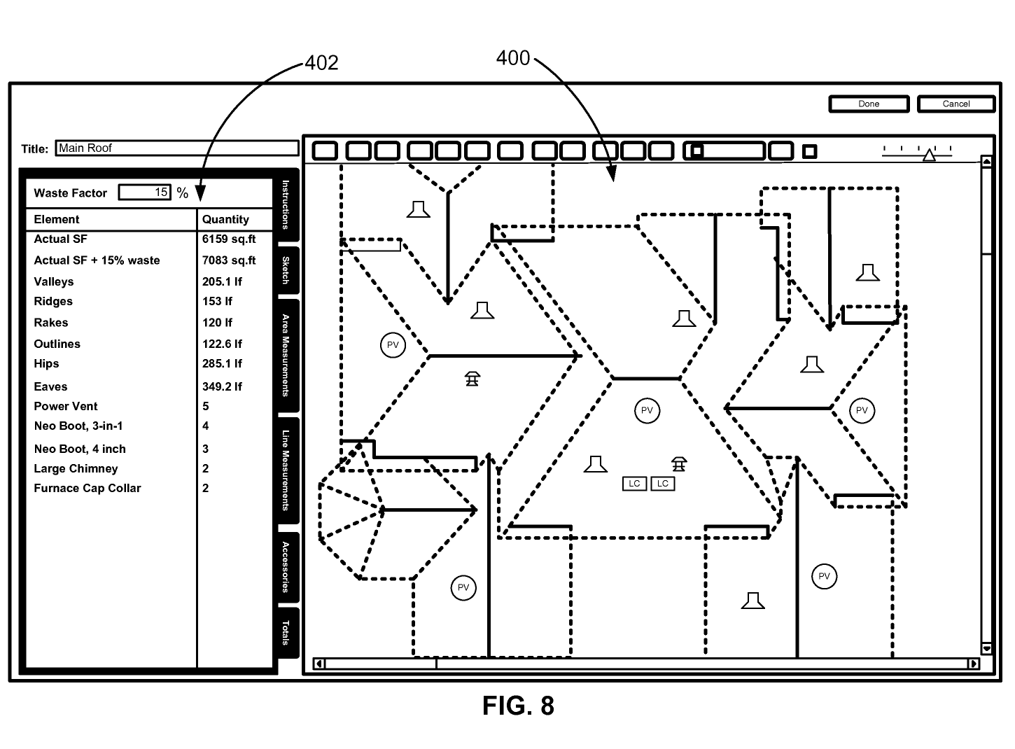

FIG. 7 shows an alternate embodiment of a repair project cost estimation page 300, according to an embodiment of the invention. The cost estimation page 300 includes an Estimate Builder 302 portion in which the user has four panels from which to create the estimate. The measurements panel 304 allows the user to enter in the measurements of the building, or portion of the building, related to the repair project. Upon entry of the relevant measurement information into the measurement panel 304, the system 10, in at least one embodiment, generates a drawing 400, such as that shown in FIG. 8. In the example of FIG. 8, the system 10 illustrates a plan view drawing 400 of a roof that is part of a repair project. Next to the drawing 400 is an information section 402 with a list of features that define and describe the drawing 400. In the embodiment of FIG. 8, the information section 402 includes data on the square footage of those portions of the roof that comprise, for example, valleys, ridges, eaves, hips, and rakes. The information section 402 also includes the number of chimneys and vents.

Referring again to FIG. 7, the Estimate Builder 302 also includes an Add Template panel 306, which allows the user to save the information entered into the Estimate Builder 302 as a template. In this manner, the data for commonly requested repair projects is stored in the template, thus saving the user time when entering data into system 10 for such commonly requested repair projects. The Estimate Builder 302 includes an Add Items panel 308 in which the user can select, for example, from a list of optional materials available for a certain type of repair project. In FIG. 7, the Add Items panel 308 includes various types of roof shingles available for a roof repair project. An Add Custom panel 310 is also included in the Estimate Builder 302. The Add Custom panel 310 allows the user to add and estimate the cost for customized features included in the repair project. These customized features listed in the Add Custom panel 310 would not normally be included in a template created in the Add Template panel 306 from the data entered for the repair project. A Tax, Overhead, Profit and Discount section 312 allows the user to enter a desired, or required, percentage of the total cost to be dedicated to taxes, overhead costs, profit or discount. In an embodiment of the invention the user will also be able to designate that the percentages entered for overhead and profit as pre-tax amounts. FIG. 7 also includes an Estimate Totals section 314 in which the total cost of the estimate is displayed.

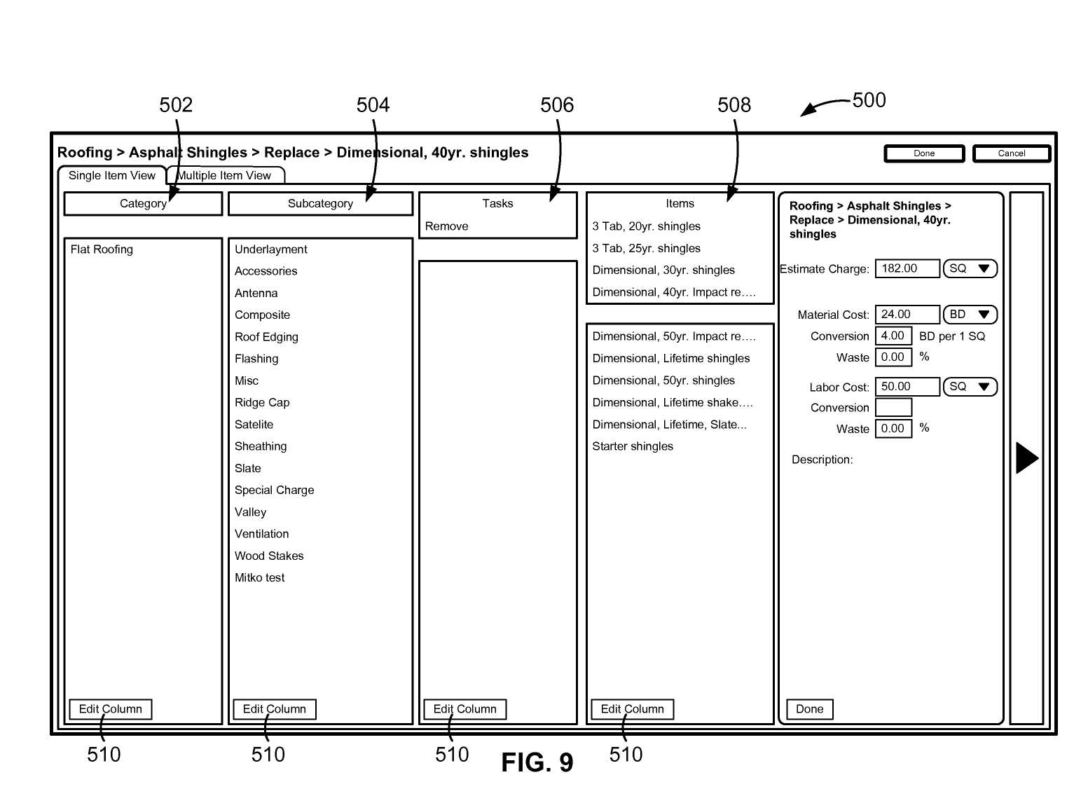

FIG. 9 shows an example of a display page 500 that summarizes the major aspects of a repair project for viewing on a single display page. In this manner, once the relevant data for a repair project has been entered, the user can review the repair project data on one page and edit the data as necessary. The embodiment of FIG. 9 includes four columns that break the repair project down by category 502 (e.g., roofing), and subcategory 504, which lists the various type of repair projects (e.g., sheathing, asphalt shingles, flashing, ventilation, etc.) that would fall under the main category 502. The embodiment of FIG. 9 shows a repair project that is further broken down according to the tasks 506 associated with each category 502 and subcategory 504, and according to Item 508, or the particular materials to be used to accomplish the tasks 506 associated with a particular category 502 and subcategory 504. Each column includes an Edit button 510 that allows the user to modify the information shown in that column.

If, based on the determination of regulatory requirements 108, the system 10 determines that a permit is needed 114, the system 10 may be configured to generate an application for the permit 116 based on user input. The system 10 may also be configured to electronically transmit, via email or facsimile for example, the application for the permit 118 to the agency responsible for providing the permit. In an embodiment of the invention, the system 10 may then be configured to provide periodic reminders to the user 120 to follow up as to the status of the permit application. In an embodiment, an indication from the user that the permit has been issued would prompt the system 10 to discontinue the reminders. If, on the other hand, the system 10 determines that no permit is needed 114, the system 10 will skip steps 116, 118, and 120.

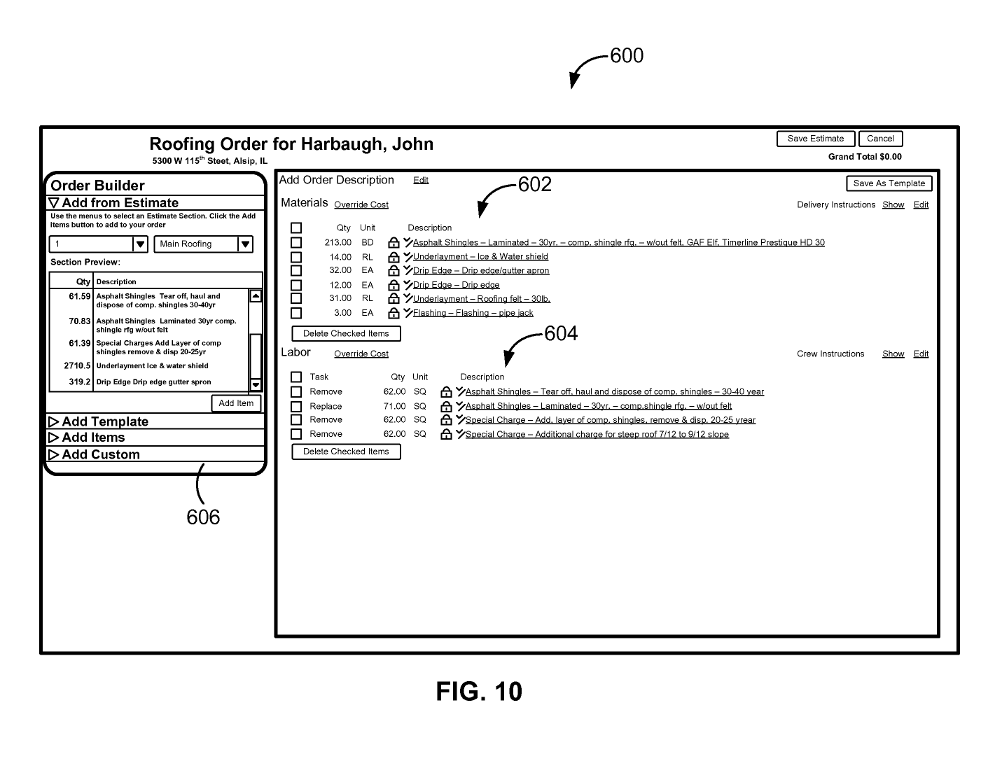

Based on the determination of material requirements 104, the system 10, in at least one embodiment, is configured to generate purchase orders for materials 122. User input would allow the system 10 to generate purchase orders 122 that include the preferred supplier, along with the current pricing and desired delivery date for any materials ordered. In an embodiment of the invention, the system 10 electronically submits the purchase orders 124, via email or facsimile for example, to the appropriate supplier. FIG. 10 shows an example of a display page 600 that provides, on a single page, a listing of all material and labor orders associated with a particular repair project. In the embodiment of FIG. 10, the material listing 602 includes the quantity and type of material. In at least one embodiment, each material listed is also a link to a another display page (not shown) that includes the supplier and cost information for that material. A task listing 604 includes a description of the labor required to complete certain tasks associated with the repair project. In at least one embodiment, each task listed is also a link to a another display page (not shown) that includes the names, contact information and cost information for completing the task. The display page 600 also allows the user to delete any entry from the material listing 602 or task listing 604 or add unique instructions to any entry from either listing 602, 604. An Order Builder section 606 allows the user to create entries for the material listing 602 and the task listing 604 using four panels similar to those described in the Estimate Builder 302 (in FIG. 7).

In an embodiment of the invention, the system 10 may then be configured to provide periodic reminders to the user 126 to follow up as to the status of material deliveries from the supplier. In an embodiment, an indication from the user that the ordered material has been delivered would prompt the system 10 to discontinue the reminders. If the supplier does not deliver the ordered materials by the date expected, the system 10 may be configured to adjust the overall project schedule 128 to account for the late material delivery.

Referring again to FIG. 5, the system 10 is configured to generate a work schedule for work crews 130 assigned to the repair project. In at least one embodiment, the work schedule includes the names of the employees, subcontractors, and independent contractors assigned to the repair project, along with the desired start date and estimated end date for each employee, subcontractor and independent contractor. The system 10 may also be configured to modify the work schedule when necessary, for example if needed materials are not delivered on time. After generating the work schedule 130, the system 10 sends the work schedule to the output device for the benefit of the user. The work schedule may be represented graphically, for example in the form of a chart, or may be shown as a calendar, for example, where the crew scheduled for any day on the calendar can be accessed by the user.

In an embodiment, the system 10 is configured to generate an overall project schedule 132. In at least one embodiment, the overall project schedule includes a timeline for each separate phase or job related to the repair project. The system 10 may also be configured to modify the overall project schedule when necessary, for example if needed materials are not delivered on time, or if members of the crew assigned to the project are not available when desired. The project schedule may be represented graphically, for example in the form of a Gantt chart, graph, or similarly suitable format.

As required by the user, the system 10 may also be configured to provide a status update 134 for any job associated with the repair project. For example, the user may seek information on the status of permit applications, material deliveries, or on-time performance for particular jobs related to the project. In at least one embodiment, the system 10 is configured to provide these status updates 134 to the output device for the benefit of the user.

In an embodiment of the invention, the system 10 is configured to display for the user a “dashboard” 136 that illustrates, for example, a list of all scheduled jobs, for all repair projects underway, to be performed in a specified time period. For example, if the specified time period is the current day, the dashboard would show a list of all jobs being performed that day 136 for every repair project being managed by the user. This list may be displayed, for example, on one portion of a computer display device. On another portion of the display device, the dashboard may include a list of all the day's appointments and meetings along with the meeting location.

On another portion of the display device, the dashboard may further include news stories of interest to system users 138, for example, news of new regulations related to the construction industry and tips for maintaining compliance with the new regulations. This section of the dashboard may also include notes and alerts relevant to particular projects or to all projects, wherein the notes and alerts are posted by system users for the purpose of informing other system users. FIGS. 7A and 7B provide two exemplary configurations for a dashboard as might be displayed in an embodiment of the invention. It is contemplated that, depending on the particular needs of the user, the dashboard may have several configurations readily available to the user. Further, it is also contemplated that these commonly available configurations may be customized according to user needs. As may be seen from FIGS. 7A and 7B, the user may use the dashboard more for disseminating news, alerts and general information, or more for disseminating information about current projects, scheduled appointments, and impending deadlines.

As mentioned above, in an embodiment of the invention, the system 10 is configured to generate customized reports 140 upon user request. While this function is not required to complete the repair project (as evidenced in the flowchart where the block for step 140 is shown off to the side of step 138), the menu of customized reports available to the user may include, but is not limited to, reports showing sales revenues, labor costs, material costs, on-time performance, profitability analysis, supplier performance, accuracy of cost estimates. In at least one embodiment, these reports may be for any time period specified by the user. The reports may encompass all projects being undertaken by the user, or the reports may be limited to cover specific repair projects. The system 10 is configured to send these reports to the output device for the benefit of the user. In at least one embodiment, the system 10 is configured to represent some report parameter graphically, for example, in the form of a graph, pie chart, or bar chart. Reports may also presented in a spreadsheet format if so desired by the user.

In an embodiment of the invention, the system 10 is configured to determine if the project is complete 142. This may be determined by checking user input. If the user has input into the system 10 that each phase or job related to the repair project has been completed, the system 10 determines that nothing more remains to be done, and may then generate a customer invoice for the work performed 144. If the user has not indicated that all jobs related the repair project are complete, the system 10 determines that the project is ongoing 142 and returns to step 134, where a current status of the repair project is provided to the user.

Once the repair project is complete, in at least one embodiment, the system 10 is configured to generate a customer invoice 144 for all work performed. The customer invoice may be sent to a computer printer for mailing to the customer, or the system 10 may be configured to transmit the invoice electronically, for example via email or facsimile to the customer. The system 10 may also be configured to track customer payments 146 and generate reminders to the user to follow up with the customer if payment has not been received within a specified time period following delivery of the invoice.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-based system for managing construction projects comprising:
an input device coupled to a processor, the input device configured to receive, from a user, input relating to a construction repair project;
an output device coupled to the processor, the output device configured to provide the user with information output by the processor; and
wherein the processor is programmed to perform the following actions based on user input:
determine material requirements for the repair project and provide the material requirement to the user via the output device;
determine the labor requirement for the repair project and provide the labor requirements to the user via the output device;
generate a cost estimate for the repair project and provide the cost estimate to the user via the output device;
generate purchase orders for materials based on the material requirements;
generate a work crew schedule based on the labor requirements; and
generate a project schedule that provides a timeline for work to be performed on the repair project.

2. The computer-based system of claim 1, wherein the processor is further programmed to generate an application for a permit required for the repair project.

3. The computer-based system of claim 2, wherein the processor is further programmed to display, via the output device, the status of any applications for permits related to the repair project.

4. The computer-based system of claim 1, wherein the processor is further programmed to electronically transmit the application for the permit to the appropriate agency.

5. The computer-based system of claim 1, wherein the processor is further programmed to generate a construction repair contract for a customer based on work to be performed for the customer.

6. The computer-based system of claim 5, wherein the processor is further programmed to generate an invoice for the customer based on work performed for the customer.

7. The computer-based system of claim 6, wherein the processor is further programmed to track profitability of a repair project based on the invoiced amount and an actual cost of the repair project.

8. The computer-based system of claim 7, wherein the processor is further programmed to provide, to the output device, a graphical representation of sales, costs and profitability data.

9. The computer-based system of claim 1, wherein the processor is further programmed to provide, to the output device, a graphical representation of the work crew schedule and the project schedule.

10. The computer-based system of claim 1, wherein the processor is further programmed to electronically transmit the material purchase order to a supplier.

11. The computer-based system of claim 1, wherein the processor is further programmed to provide, to the output device, a calendar of events for a specified time period.

12. The computer-based system of claim 11, wherein the time period is the current day, and the calendar of events includes one of a list of work scheduled to be performed during the current day and a list of scheduled appointments for the current day.

13. The computer-based system of claim 1, wherein the processor is further programmed to provide to the output device a list of all repair projects currently in progress.

14. The computer-based system of claim 1, wherein the processor is further programmed to allow the user to search among all of the repair projects in the computer-based system.

15. The computer-based system of claim 14, wherein the search may be based on one of a customer name, a job number, a location, and a supplier.

16. The computer-based system of claim 1, wherein the processor is further programmed to provide the user with customized reports.

17. The computer-based system of claim 16, wherein the customized reports may include one or more of revenue from sales, labor costs, on-time performance, profits, and material costs for a specified time period.

18. The computer-based system of claim 1, wherein the processor is further programmed to provide updates to the user on the current status of the repair project.

19. The computer-based system of claim 1, wherein the processor is further programmed to provide the user with one of news, alerts and notes regarding the repair project.

20. The computer-based system of claim 1, wherein the output device is one of an electronic display and a printer.

21. A computer-readable storage medium having program instructions stored thereon, which, when executed, cause the computer to:
process input needed to initiate a construction repair project;
determine material requirements for the repair project;
determine the labor requirement for the repair project;
generate a cost estimate for the repair project;
generate purchase orders for materials based on the material requirements;
generate a work crew schedule based on the labor requirements;
generate a project schedule that provides a timeline for work to be performed on the repair project; and
provide updates to the user regarding the current status for the repair project.

22. The computer-readable storage medium of claim 21, wherein the program instructions, when executed, further cause the computer to generate an application for a permit required for the repair project, and to electronically transmit the application for the permit to the appropriate agency.

23. The computer-readable storage medium of claim 21, wherein the program instructions, when executed, further cause the computer to generate a construction repair contract for a customer based on work to be performed for the customer.

24. The computer-readable storage medium of claim 21, wherein the program instructions, when executed, further cause the computer to generate an invoice for the customer based on work performed for the customer.

25. The computer-readable storage medium of claim 21, wherein the program instructions, when executed, further cause the computer to:
display a calendar of events for a specified time period, wherein the calendar of events includes one of a list of work scheduled to be performed during the specified time period and a list of scheduled appointments for the specified time period; and
display a list of all repair projects currently in progress.

26. The computer-readable storage medium of claim 21, wherein the program instructions, when executed, further cause the computer to provide the user with customized reports, wherein the customized reports may include one or more of revenue from sales, labor costs, on-time performance, profits, and material costs for a specified time period.
